(19) United States
(12) Patent Application Publication
(10) Pub. No.: US 2003/0236863 A1
(43) Pub. Date: Dec. 25, 2003

(54) Just-in-time multicasting

(76) Inventors: Peter E. Johnson, Lehi, UT (US); David A. Eatough, Herriman, UT (US)

Correspondence Address: KENYON & KENYON, 1500 K STREET, N.W., SUITE 700, WASHINGTON, DC, 20005, US

(21) Appl. No.: 10/178,472

(22) Filed: Jun. 25, 2002

(51) Int. Cl. G06F 15/16

(52) U.S. Cl. 709/219; 709/231

(57) ABSTRACT

A method of multicasting data from a server computer to a plurality of client computers includes receiving a request for data from one of the plurality of client computers. The method further includes determining whether to multicast the data in response to the request and multicasting the data to the plurality of clients based on the request if it is determined to multicast.

### FIELD OF THE INVENTION

One embodiment of the present invention is directed to transferring computer data. More particularly, one embodiment of the present invention is directed to multicasting computer data.

### BACKGROUND INFORMATION

Computer networks, formed by a small or large number of computers connected together by communication lines, are increasingly popular. One issue with computer networks is the need to easily manage all of the computers when new software must be installed, or when software updates are required. It is very time consuming to have to individually install new or upgraded software onto each computer in the network when necessary.

A known method of upgrading or installing software is to send needed data from one computer to other computers over the network. With one method, referred to as “multicasting”, a multicast server computer sends one set of data to multiple multicast recipient client computers. This avoids the need for a server to send the same set of data multiple times, therefore saving both network and server resources.

One problem with known multicast technology is that data is frequently sent from the multicast server whether any client computer needs the data or not. Known multicast servers do not respond to requests from clients. Therefore, network and server resources can be wasted when data that is not needed by any clients is unnecessarily sent to all clients.

Based on the foregoing, there is a need for a system and method for multicasting data that can respond to client requests and will avoid sending data that is not needed by any clients.

### BRIEF DESCRIPTION OF THE DRAWINGS

FIG. 1 is an overview diagram of a computer network in accordance with one embodiment of the present invention.

FIG. 2 is a flow diagram of the functionality of a multicast process performed by a server and clients in accordance with one embodiment of the present invention in order to multicast files on a just-in-time basis to install a software application.

### DETAILED DESCRIPTION

One embodiment of the present invention is a just-in-time multicast system in which multicasting is initiated upon a request from at least one client. Therefore, only files that are needed by at least one client are multicast from a multicast server.

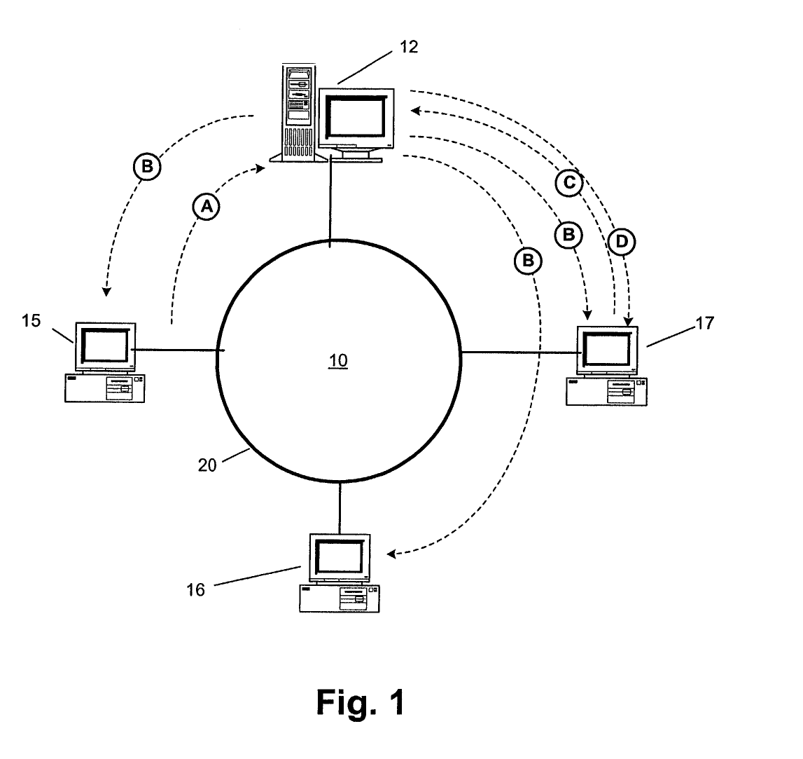

FIG. 1 is an overview diagram of a computer network 10 in accordance with one embodiment of the present invention. Network 10 includes a multicast server computer 12 coupled to a plurality of client computers 15-17 over communication line 20. Computer network 10 can be any type of network that allows computer 12 to communicate and send files to client computers 15-17. In one embodiment, network 10 is a token ring network. In another embodiment, network 10 is an Ethernet network.

Multicast server computer 12 can be any type of computer that stores files that are to be multicast to client computers 15-17. In one embodiment, server computer 12 includes a processor, memory, and a network interface device. In one embodiment, the files to be multicast are stored on a CD-ROM drive (not shown) coupled to server 12, or are stored in memory of server 12. The memory may be cache memory. In one embodiment, server 12 stores on its memory and executes on its processor an operating system that includes server multicast functionality. In one embodiment, the operating system is Windows XP from Microsoft Corp.

Client computers 15-17 can be any type of computers that can communicate with server computer 12 in order to send request to server 12 and receive files from server 12. In one embodiment, client computers 15-17 include a processor, memory, and a network interface device. In one embodiment, a portion of the memory functions as cache memory. In one embodiment, computers 15-17 store on their memory and execute on their processor an operating system that includes a software installation function. In one embodiment, the operating system is Windows XP from Microsoft Corp.

In one embodiment, multicast server 12 is required to install a complex software application, such as Office 2000 from Microsoft Corp., on each client 15-17. The software application includes multiple files, but all clients 15-17 may not need each file. In one embodiment, server 12 does not multicast the files until a client needs the files to perform the software installation. When installing complex software applications, the files that will be used by each client, and the order in which they will be used, will likely be slightly different from platform to platform. One embodiment of the present invention allows the clients to determine the order that the files are requested.

The software installation can be started either from a centralized scheduling application, a local scheduling application, any other type of scheduling operation, manually by a user at the computer, or manually by an administrator at a remote. When the installation is started, each client 15-17 in one embodiment is in control of its local installation and notices that it is in need of a file. The client (e.g., client 15) requests the file from multicast server 12 (data flow A of FIG. 1). In response to this request, the requested file is multicast to all clients 15-17 by server 12 (data flows B). Clients 15-17 place this file in their individual cache for use by the software installer. This process is repeated for all the files that need to be processed or installed on clients 15-17.

If during the multicast process any of clients 15-17 run out of room in their cache, they will begin discarding the older files for the next file being multicast. If during the multicast process a client falls behind the other clients or otherwise misses a file that has been multicast and has been purged from its local cache, it will request the file from multicast server 12 (data flow C). Assuming multicast server 12 has just recently multicast the file, it will not multicast the file again. Instead, it will transmit the file directly to the client using a point to point protocol (data flow D). In another embodiment, multicast server 12 could multicast the file several times before transmitting the file using a point to point protocol.

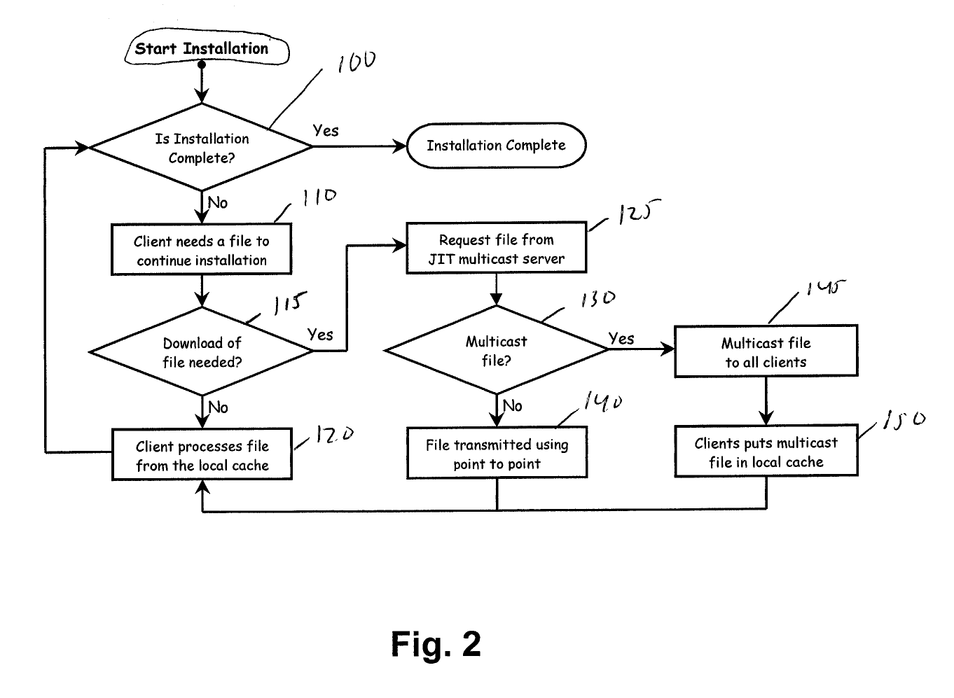

FIG. 2 is a flow diagram of the functionality of a multicast process performed by server 12 and clients 15-17 in accordance with one embodiment of the present invention in order to multicast files on a just-in-time basis to install a software application. In one embodiment, the functionality is implemented by software stored in memory and executed by a processor. In other embodiments, the functionality can be performed by hardware, or any combination of hardware and software.

At decision point 100, clients 15-17 determine whether the installation of the software is complete. If so, the multicast process is over. If not, at box 110 one or more of clients 15-17 determine that a file is needed to continue the installation.

At decision point 115, a client that needs a file determines whether a download of the file is needed. A download would not be needed if a copy of the file is stored in the client's local cache from a previous multicast download. If a download is not needed, at box 120 the client processes the file from its local cache, and the multicast process jumps to decision point 100.

If it is determined at decision point 115 that a client needs a download of a file, then at box 125 the client requests the file from multicast server 12 through any request of signaling method over the network.

At decision point 130, in response to the request at box 125, multicast server 12 determines whether to multicast the requested file. In one embodiment, the determination is time based, so if the file has not been multicast in the past X hours it should be multicast. In another embodiment, the determination is frequency based, so if the file has not been multicast at least N times then it should be multicast again. In other embodiments, the determination could be based on a combination of the above, or another criteria.

If multicast server 12 determines to not multicast the file at decision point 130, then at box 140 the file is transmitted to the requesting client point to point. The multicast process then jumps to box 120.

If multicast server 12 determines to multicast the file at decision point 130, then at box 145 the file is multicast to all of clients 15-17 using standard multicast techniques. At box 150, the clients then store the multicast file in their local cache, and the multicast process then jumps to box 120. In other embodiments, a broadcast protocol can be used instead of a multicast protocol.

In other embodiments, the data being multicast could be stream-based rather than file-based. An example of the stream could be media such as sound or video. Further, in other embodiments the data being multicast could be non-critical, such that a request for data that has already been sent out will not be sent out again either by multicast or any other means. In this case, embodiments of the present invention could decrease the amount of lost data. Further, in other embodiments, the data being multicast could be randomly accessed portions of a large file or files. In this case the local cache of clients 15-17 would need to be able to cache portions of files as well as whole files.

As described, one embodiment of the present invention provides just-in-time multicasting based on requests from clients. Several advantages result from this approach. For one, one embodiment of the present invention allows for the client to determine the order of files while allowing the rest of the multicast to proceed as it does in traditional systems. This is particularly helpful when the amount of data that needs to be multicast is larger than the cache size on the individual client.

One problem with prior art multicast systems is that data is sent to all clients, whether a client needs it or not. One embodiment of the present invention solves the problem by not multicasting the data until a client needs it. If none of the clients need the data, it will not be multicast.

Another problem with prior art multicast systems occurs when the total set of data is too large to be cached on each client. This becomes a problem because the client cannot cache all of the information. Typically when a cache is overloaded some of the data will be discarded to make room for the new data. For a large installation a problem occurs when all of the possible files are sent to the client and the client does not know which files to keep and which files to discard. Not having enough room in the cache, the client will often discard files that will be needed by the client, while keeping files that are not needed. In contrast, one embodiment of the present invention allows existing systems to make use of multicasting while only requiring each client to reserve a minimum amount of space for a cache.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method of multicasting data from a server computer to a plurality of client computers, said method comprising:
receiving a request for a first data from a first client computer of the plurality of client computers;
determining whether to multicast the first data in response to the request; and
multicasting the first data to the plurality of clients based on the request if it is determined to multicast.

2. The method of claim 1, further comprising:
sending the first data only to the first client computer if it is determined not to multicast.

3. The method claim 1, wherein the first data comprises a data file.

4. The method of claim 1, wherein the determination is time based.

5. The method of claim 1, wherein the determination is frequency based.

6. The method of claim 1, further comprising:
determining at the first client whether a download of the first data is needed.

7. The method of claim 6, further comprising:
retrieving the first data from a local cache if the first client determines that the download is not needed.

8. The method of claim 1, further comprising:
storing the first data in a local cache at each of the plurality of clients.

9. A method of multicasting data from a server computer to a plurality of client computers, said method comprising:
receiving a request for a first data from at least a first client computer of the plurality of client computers; and
multicasting the first data to the plurality of clients based on the request.

10. The method of claim 9, further comprising:
determining whether to multicast the first data in response to the request.

11. The method of claim 10, further comprising:
sending the first data only to the first client computer if it is determined not to multicast.

12. The method claim 9, wherein the first data comprises a data file.

13. The method of claim 10, wherein the determination is time based.

14. The method of claim 10, wherein the determination is frequency based.

15. The method of claim 9, further comprising:
determining at the first client whether a download of the first data is needed.

16. The method of claim 15, further comprising:
retrieving the first data from a local cache if the first client determines that the download is not needed.

17. The method of claim 9, further comprising:
storing the first data in a local cache at each of the plurality of clients.

18. A server computer coupled to a plurality of client computers, said server computer comprising:
a processor; and
a memory coupled to said processor;
said memory having instructions stored thereon which, when executed by said processor, cause said processor to:
receive a request for a first data from a first client computer of the plurality of client computers;
determine whether to multicast the first data in response to the request; and
multicast the first data to the plurality of clients based on the request if it is determined to multicast.

19. The server computer of claim 18, said memory further storing instructions that cause said processor to:
send the first data only to the first client computer if it is determined not to multicast.

20. The server computer of claim 18, wherein the first data comprises a data file.

21. The server computer of claim 18, wherein the determination is time based.

22. The server computer of claim 18, wherein the determination is frequency based.

23. A computer readable medium having instructions stored thereon that, when executed by a processor, cause the processor to:
receive a request for a first data from a first client computer of the plurality of client computers;
determine whether to multicast the first data in response to the request; and
multicast the first data to the plurality of clients based on the request if it is determined to multicast.

24. The computer readable medium of claim 23, said memory further storing instructions that cause said processor to:
send the first data only to the first client computer if it is determined not to multicast.

25. The computer readable medium of claim 23, wherein the first data comprises a data file.

26. The computer readable medium of claim 23, wherein the determination is time based.

27. The computer readable medium of claim 23, wherein the determination is frequency based.
